(19) United States
(12) Patent Application Publication
(10) Pub. No.: US 2023/0174687 A1
(43) Pub. Date: Jun. 8, 2023

(54) PROCESS FOR THE PREPARATION OF BROMINATED COPOLYMERS OF CONJUGATED DIENES AND STYRENIC MONOMERS

(71) Applicant: LANXESS Corporation, Pittsburgh, PA (US)

(72) Inventors: Christopher Simpson, Cheshire, CT (US); David W. Bartley, El Dorado, AR (US); Roy Pickering, Waldo, AR (US); David J. Sikora, Middlebury, CT (US)

(73) Assignee: LANXESS Corporation, Pittsburgh, PA (US)

(21) Appl. No.: 17/920,259

(22) PCT Filed: Apr. 16, 2021
(86) PCT No.: PCT/US2021/027700

§ 371 Date: Oct. 20, 2022

Related U.S. Application Data
(60) Provisional application No. 63/012,961, filed on Apr. 21, 2020.

(51) Int. Cl. C08F 8/20; C08F 297/04; C08L 53/02

(52) U.S. Cl. CPC C08F 8/20; C08F 297/04; C08L 53/025; C08L 2201/02

(57) ABSTRACT

A brominated copolymer of at least one conjugated diene and at least one styrenic monomer is prepared such that at least 45 percent, but no more than 70 percent, of the non-aromatic double bonds In the copolymer are brominated. The produced brominated copolymer is useful as a flame retardant and exhibits surprisingly small domain sizes after dissolution in styrenic monomer which is subsequently polymerized.

The present invention relates to brominated copolymers of at least one conjugated diene and at least one styrenic monomer as flame retardants, prepared such that at least 45 percent, but no more than 70 percent, of the non-aromatic double bonds in the copolymers are brominated.

U.S. Pat. Nos. 7,851,558 and 8,202,945 disclose preparing thermally stable brominated butadiene/vinyl aromatic copolymers as flame retardant additives for vinyl aromatic polymer compositions. It is disclosed that residual (unbrominated) butadiene double bonds in the brominated copolymer can lead to undesirable cross-linking reactions, particularly when the brominated copolymer is blended with a vinyl aromatic polymer. Preferred brominated butadiene/vinyl aromatic copolymers are fully brominated or nearly so, meaning all or nearly all (e.g., up to 95%, up to 99% or 100%) of the double bonds or unsaturation present in the butadiene moiety prior to bromination are brominated.

This flame retardant, however, exhibits domain sizes after dissolution in styrenic monomer which is subsequently polymerized which may be too large and have the potential to interfere with foam cell formation and cell size, such as in the manufacture of expanded styrenic polymer foams.

In accordance with the present invention, it was discovered that brominating a copolymer of at least one conjugated diene and at least one styrenic monomer under conditions sufficient to brominate at least 45 percent, but no more than 70 percent, of the non-aromatic double bonds in the copolymer produces a brominated copolymer of conjugated diene/styrenic monomer exhibiting surprisingly small domain sizes after dissolution in styrenic monomer which is subsequently polymerized.

Disclosed herein is a process for producing a brominated copolymer flame retardant of at least one conjugated diene and at least one styrenic monomer, comprising reacting a copolymer of at least one conjugated diene and at least one styrenic monomer with a brominating agent in the presence of a solvent for the copolymer under conditions sufficient to brominate at least 45 percent, but no more than 70 percent, of the non-aromatic double bonds in the copolymer, wherein the copolymer contains, prior to bromination, from 20 to 50 percent by weight of polymerized styrenic monomer units and from 50 to 80 percent by weight of polymerized conjugated diene units, and has a weight average molecular weight of at least 1,000 g/mol.

In a further aspect, a brominated copolymer flame retardant of at least one conjugated diene and at least one styrenic monomer is produced according to the process disclosed herein. In another aspect, a brominated copolymer flame retardant of at least one conjugated diene and at least one styrenic monomer is disclosed, the copolymer having, prior to bromination, from 20 to 50 percent by weight of polymerized styrenic monomer units and from 50 to 80 percent by weight of polymerized conjugated diene units and a weight average molecular weight of at least 1,000 g/mol, and wherein at least 45 percent, but no more than 70 percent, of the non-aromatic double bonds in the brominated copolymer are brominated.

Unless otherwise specified, the word “a” or “an” in this application means “one or more than one”.

The copolymer starting material is a copolymer of at least one conjugated diene and at least one styrenic monomer. As used herein, a “styrenic monomer” refers to a compound having one or more (often one) vinyl groups (CH₂═CR—, where R is hydrogen or methyl) bonded directly to a ring carbon of an otherwise unsubstituted or alkyl-substituted (e.g., C₁-C₁₂ alkyl- or C₁-C₆ alkyl-substituted) aromatic ring, such as a benzene ring. Preferred styrenic monomers include styrene, a-methylstyrene, 2-methylstyrene, 4-methylstyrene, dimethyl styrene, 2-ethylstyrene, 4-ethylstyrene, diethylstyrene, tert-butylstyrene, 2-isopropylstyrene, 4-isopropylstyrene, vinyl toluene, divinyl benzene and mixtures thereof. Preferably, styrene is used, for example, as the sole styrenic monomer or, if more than one styrenic monomer is used, as the majority component by weight of the styrenic monomers. Preferred conjugated dienes have 4 to 8 carbon atoms, such as butadiene, isoprene, 2,3-dimethylbutadiene, 1,3-pentadiene, 1,3-hexadiene and mixtures thereof. Preferably, butadiene is used, for example, as the sole conjugated diene or, if more than one conjugated diene is used, as the majority component by weight of the conjugated dienes.

As used herein, “polymerized styrenic monomer units” refer to repeating units in the copolymer starting material that are formed when at least one styrenic monomer is polymerized. Similarly, as used herein, “polymerized conjugated diene units” refer to repeating units in the copolymer starting material that are formed when at least one conjugated diene is polymerized. The starting copolymer contains from 50 to 80 percent by weight of polymerized conjugated diene units and from 20 to 50 percent by weight of polymerized styrenic monomer units, such as from 60 to 75 percent by weight of polymerized butadiene units and from 25 to 40 percent by weight of polymerized styrenic monomer units.

Butadiene polymerizes to form two types of repeating units. “1,2-butadiene units,” as referred to herein, take the form

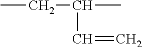

and so introduce pendant unsaturated groups to the polymer. The second type, referred to herein as “1,4-butadiene units,” take the form —CH₂—CH═CH—CH₂—, introducing unsaturation into the main polymer chain. Often, at least 10% of the butadiene units in a starting copolymer of butadiene and a styrenic monomer are 1,2-butadiene units, such as at least 15%, at least 20% or at least 25% of the butadiene units. In many embodiments, at least 50% of the butadiene units are 1,2-butadiene units, such as at least 60%, at least 70%, at least 80%, or at least 90% of the butadiene units. In many embodiments, from 50% to 95% of the butadiene units in the copolymer are 1,2-butadiene units.

The copolymer starting material of conjugated diene/styrenic monomer may have a weight average molecular weight (M_{w}) ranging from 1,000 to 400,000 g/mol, such as from 2,000 to 300,000 g/mol, from 5,000 to 200.000 g/mol, or from 10,000 to 180,000 g/mol. As used herein, weight average molecular weights are apparent molecular weights measured by Gel Permeation Chromatography (GPC) relative to a polystyrene standard.

The copolymer of conjugated diene/styrenic monomer may be a random, block or graft type of copolymer. In many embodiments, the copolymer is a block copolymer containing one or more polymerized conjugated diene blocks and one or more polymerized styrenic monomer blocks. The copolymer of conjugated diene/styrenic monomer may be any of a diblock, triblock, tetrablock or further multiblock copolymer. Preferably, the copolymer of at least one conjugated diene and at least one styrenic monomer contains one or more polystyrene blocks and one or more polybutadiene blocks. In many embodiments, the block copolymer starting material is a triblock copolymer, such as a triblock copolymer having a central polybutadiene block and terminal polystyrene blocks (styrene-butadiene-styrene).

The brominating agent may be elemental bromine or another brominating agent, such as those known in the art. For example, the brominating agent may comprise a combination of elemental bromine and a solvent, such as a chlorinated hydrocarbon (e.g., dichloromethane or carbon tetrachloride), or a solvent blend, such as a blend of chlorinated hydrocarbons and/or cyclic ethers (such as tetrahydrofuran).

In many embodiments, the brominating agent comprises a tribromide chosen from pyridinium tribromide, a phenyltrialkylammonium tribromide, a benzyltrialkylammonium tribromide and a tetra-alkylammonium tribromide. Examples include phenyltrimethylammonium tribromide, benzyltrimethylammonium tribromide, tetramethylammonium tribromide, tetraethylammonium tribromide, tetrapropylammonium tribromide, tetra-n-butylammonium tribromide, and the like. The brominating agent may comprise a solvent for the tribromide, such as to facilitate blending with the copolymer of conjugated diene/styrenic monomer and the solvent for the copolymer.

The tribromide can be prepared by mixing the corresponding quaternary ammonium monobromide salt with elemental bromine, such as by adding elemental bromine to an aqueous solution of the monobromide salt. The tribromide tends to precipitate from the aqueous phase, and so may be recovered from the liquid phase by any convenient solid-liquid separation method.

In addition, the tribromide brominating agent may be formed in situ in the presence of the solvent and/or the copolymer of conjugated diene/styrenic monomer by separately adding elemental bromine and the corresponding quaternary ammonium monobromide salt. It is believed that the bromine and monobromide salt form the tribromide upon being mixed together, with the resulting tribromide then reacting with the copolymer of conjugated diene/styrenic monomer to brominate the copolymer and regenerate the monobromide salt. As elemental bromine is consumed in this reaction sequence, more bromine may be added to the reaction mixture continuously or intermittently to reproduce the tribromide and maintain the reaction. Continuous and semi-continuous processes for adding elemental bromine and/or fresh starting copolymer for forming the quaternary ammonium tribromide in situ, brominating the copolymer, and regenerating the monobromide salt are described in the art, such as in U.S. Pat. No. 8,202,945.

Suitable solvents for the copolymer of conjugated diene/styrenic monomer include ethers, such as tetrahydrofuran, halogenated alkanes, such as carbon tetrachloride, chloroform, dichloromethane, bromochloromethane and 1,2-dichloroethane; hydrocarbons, such as cyclohexane, cyclopentane, cyclooctane and toluene, and halogenated aromatic compounds, such as bromobenzene, chlorobenzene and dichlorobenzene. Often, the solvent has a boiling temperature (at atmospheric pressure) of less than 100° C., such as less than 80° C., is substantially immiscible in water, is aprotic, and does not contain oxygen or hydrogen atoms bonded to a tertiary carbon. In many embodiments, the solvent is a halogenated or hydrocarbon solvent. For example, halogenated alkanes, halogenated aromatic compounds, and cyclic alkanes that contain no hydrogen atoms bonded to a tertiary carbon atom are often used.

The solvent is used in quantities sufficient to dissolve the copolymer of conjugated diene/styrenic monomer under the conditions of the reaction. The concentration of the copolymer in the solvent may range from, for example, 1 to 35% by weight, such as from 5 to 25% by weight.

Often, the brominating agent is added to a solution of the copolymer starting material and solvent.

In accordance with the present disclosure, the copolymer of at least one conjugated diene and at least one styrenic monomer is brominated by reacting the copolymer with the brominating agent in the presence of the solvent under conditions sufficient to brominate at least 45 percent, but no more than 70 percent, of the non-aromatic double bonds in the copolymer. For example, in many embodiments, the degree of bromination of the non-aromatic double bonds ranges from 50 to 68 percent, from 50 to 65 percent, or from 55 to 65 percent.

The required range of bromination of the non-aromatic double bonds can be achieved, for example, by controlling in the reaction mixture the ratio of the brominating agent to the polymerized conjugated diene units in the copolymer and/or the amount of time the brominating agent is reacted with the copolymer. Often, the bromination reaction involves from 0.45 mole to about 0.70 mole of the brominating agent per mole of conjugated diene units in the copolymer. Higher molar ratios may be used, such as up to about 1 mole, or as high as about 2 moles, of the brominating agent per mole of conjugated diene units, while controlling reaction kinetics to achieve bromination of no more than 70 percent (such as, in some embodiments, no more than 68 percent or no more than 65 percent) of the non-aromatic double bonds. For example, reaction time and temperature can be controlled to achieve bromination in the required range. Accordingly, in some embodiments, from 0.45 mole up to about 2 moles, from 0.48 mole up to about 1.5 moles, or from 0.50 mole up to about 1 mole of the brominating agent are reacted per mole of conjugated diene units in the copolymer, where the degree of bromination of the non-aromatic double bonds in the copolymer is no more than 70 percent (such as, in some embodiments, no more than 68 percent or no more than 65 percent). In some embodiments, at least 0.45 mole, but less than 1 mole, of the brominating agent are reacted per mole of conjugated diene units in the copolymer, such as from about 0.50 mole to about 0.68 mole or from about 0.55 mole to about 0.65 mole of the brominating agent per mole of conjugated diene units.

Generally, only mild conditions are needed to effect the bromination. Bromination temperatures may range from −20 to 100° C., such as from 0 to 85° C. or from 0 to 40° C. In some embodiments, the reaction temperature ranges from 10 to 40° C.

In cases where the brominated copolymer is insoluble in the reaction mixture, the product can be recovered using any convenient solid/liquid separation method such as filtration, decantation or the like. If the brominated copolymer remains soluble in the reaction mixture, it is conveniently isolated from the mixture through a suitable method such as distillation of the solvent, or addition of an anti-solvent which causes the brominated copolymer to become insoluble and precipitate. Examples of such anti-solvents include lower alcohols such as methanol, ethanol and 1-propanol, 2-propanol, n-butanol, and t-butanol. The isolated brominated copolymer may be purified, such as known in the art, to remove residual bromine, brominating agent, solvent and by-products as desired or needed for a particular application.

The extent of bromination of the non-aromatic double bonds is determined using proton Nuclear Magnetic Resonance spectroscopy (¹H-NMR). In particular, residual double bond percentage, polymerized monomer contents and 1,2 butadiene isomer content can be determined by comparing integrated areas of signals due to relevant protons.

The copolymer of conjugated diene/styrenic monomer is preferably selectively brominated such that the brominated copolymer contains no more than 2% by weight, such as no more than 1%, or less than 1%, by weight, of aromatically bound bromine. Often, the brominated copolymer of conjugated diene/styrenic monomer produced according to the present disclosure has a bromine content by weight ranging from 47 to 60%, such as from 50 to 58% or from 50 to 56%. The bromine content in the brominated copolymer is determined by potentiometric titration after treatment with sodium biphenyl reagent, as known in the art for organic halogens.

The degree of bromination of at least 45 percent, but no more than 70 percent, of the non-aromatic double bonds in the copolymer of conjugated diene/styrenic monomer results in the copolymer exhibiting surprisingly small domain sizes after dissolution in subsequently polymerized styrenic monomer. In some embodiments, the resulting domain sizes of the brominated copolymer after dissolution in subsequently polymerized styrenic monomer are less than 10 microns, such as 8 microns or less, e.g., from 1 micron or less, or from 2 microns or less, to 8 microns. In some embodiments, the average domain size of the brominated copolymer after dissolution in subsequently polymerized styrenic monomer is less than 6 microns, such as 5 microns or less, e.g., from 1 to 5 microns, or from 2 microns or less, or from 3 microns or less, to 5 microns. In many embodiments, the styrenic monomer is styrene. Domain sizes of the brominated copolymer in the styrenic polymer matrix are measured using scanning electron microscopy (SEM) imaging on cross-sectioned samples.

The brominated copolymer as described herein exhibits excellent compatibility (and minimal impact) within the polymerization of styrenic monomers, and is provided in an amount effective to provide flame retardancy to the resulting styrenic polymer. Often, an amount useful to provide effective flame retardancy is an amount sufficient to provide a bromine content of from 0.5 to 10% by weight, based on the weight of the blend. The styrenic polymer compositions may include other additives, such as other flame retardant additives, flame retardant adjuvants, thermal stabilizers, ultraviolet light stabilizers, nucleating agents, antioxidants, foaming agents, acid scavengers and coloring agents.

The following Examples serve to further illustrate the invention; they do not limit the scope thereof.

### EXAMPLES

### Example 1

To a 250-mL round-bottom flask equipped with overhead stirring, addition funnel, and a nitrogen inlet were added 95 g of dichloromethane and 5.0 g of a styrene-butadiene-styrene triblock copolymer having 32 wt. % polymerized styrene units and 68 wt. % polymerized butadiene units (0.0623 mol eq., of which 82 wt. % were 1,2-butadiene units and 18 wt. % were 1,4-butadiene units) and a total weight average molecular weight (M_{w}) of 93,000 g/mol measured by GPC relative to a polystyrene standard. The mixture was allowed to dissolve fully. To the 100-mL addition funnel was added 21 mL (0.0378 mol, 1.8 M solution in dichloromethane) of tetraethylammonium tribromide. The solution was added via drop wise addition to the polymer solution over 5 minutes. After 2 hours at reflux the reaction was allowed to cool to room temperature and a reaction aliquot was taken and precipitated into methanol. The resulting precipitate was filtered, and the solids were washed with methanol. ¹H-NMR indicated that 60% of the non-aromatic double bonds in the copolymer were brominated (i.e., 60% conversion of butadiene units). The bromine content by weight in the resulting copolymer was 55%, measured by potentiometric titration after treatment with sodium biphenyl reagent.

### Example 2a (Comparative)

To a 250-mL round-bottom flask equipped with overhead stirring, addition funnel, and a nitrogen inlet were added 95 g of dichloromethane and 5.0 g of a styrene-butadiene-styrene triblock copolymer having 32 wt. % polymerized styrene units and 68 wt. % polymerized butadiene units (0.0623 mol eq., of which 82 wt. % were 1,2-butadiene units and 18 wt. % were 1,4-butadiene units) and a total weight average molecular weight (Me) of 93,000 g/mol measured by GPC relative to a polystyrene standard. The mixture was allowed to dissolve fully. To the 100-mL addition funnel was added 37 mL (0.0661 mol, 1.8 M solution in dichloromethane) of tetraethylammonium tribromide. The solution was added via drop wise addition to the polymer solution over 5 minutes. After 2 hours at reflux the reaction was allowed to cool to room temperature and a reaction aliquot was taken and precipitated into methanol. The resulting precipitate was filtered, and the solids were washed with methanol. ¹H-NMR indicated that 96% of the non-aromatic double bonds in the copolymer were brominated (i.e., 96% conversion of butadiene units). The bromine content by weight in the resulting copolymer was 66%, measured by potentiometric titration after treatment with sodium biphenyl reagent.

### Example 2B (Comparative)

To a 250-mL round-bottom flask equipped with overhead stirring, addition funnel, and a nitrogen inlet were added 95 g of dichloromethane and 5.0 g of a styrene-butadiene-styrene triblock copolymer having 32 wt. % polymerized styrene units and 68 wt. % polymerized butadiene units (0.0623 mol eq., of which 82 wt. % were 1,2-butadiene units and 18 wt. % were 1,4-butadiene units) and a total weight average molecular weight (M_{w}) of 93,000 g/mol measured by GPC relative to a polystyrene standard. The mixture was allowed to dissolve fully. To the 100-mL addition funnel was added 30 mL (0.0541 mol, 1.8 M solution in dichloromethane) of tetraethylammonium tribromide. The solution was added via drop wise addition to the polymer solution over 5 minutes. After 2 hours at reflux the reaction was allowed to cool to room temperature and a reaction aliquot was taken and precipitated into methanol. The resulting precipitate was filtered, and the solids were washed with methanol. ¹H-NMR indicated that 86% of the non-aromatic double bonds in the copolymer were brominated (i.e., 86% conversion of butadiene units). The bromine content by weight in the resulting copolymer was 63%, measured by potentiometric titration after treatment with sodium biphenyl reagent.

### Example 2C (Comparative)

To a 250-mL round-bottom flask equipped with overhead stirring, addition funnel, and a nitrogen inlet were added 95 g of dichloromethane and 5.0 g of a styrene-butadiene-styrene triblock copolymer having 32 wt. % polymerized styrene units and 68 wt. % polymerized butadiene units (0.0623 mol eq., of which 82 wt. % were 1,2-butadiene units and 18 wt. % were 1.4-butadiene units) and a total weight average molecular weight (M_{w}) of 93,000 g/mol measured by GPC relative to a polystyrene standard. The mixture was allowed to dissolve fully. To the 100-mL addition funnel was added 27.3 mL (0.0491 mol, 1.8 M solution in dichloromethane) of tetraethylammonium tribromide. The entire solution was added via drop wise addition to the polymer solution over 5 minutes. After 2 hours at reflux the reaction was allowed to cool to room temperature and a reaction aliquot was taken and precipitated into methanol. The resulting precipitate was filtered, and the solids were washed with methanol. ¹H-NMR indicated that 78% of the non-aromatic double bonds in the copolymer were brominated (i.e., 78% conversion of butadiene units). The bromine content by weight in the resulting copolymer was 61%, measured by potentiometric titration after treatment with sodium biphenyl reagent.

### Example 3—Domain Size Testing

Sample Preparation.

For each of the brominated block copolymers (Br-SBS) synthesized in the above Examples, 0.02 g of the brominated block copolymer and 2 g of styrene monomer were added to a 20 mL glass vial. The mixture was sealed and placed on an orbital shaker for 2 hours to allow complete dissolution. The samples were then polymerized under standard conditions (temperature of 100° C. for a minimum of 18 hours) to allow complete conversion to polymer. Sample discs were then cross sectioned and scanning electron microscope (SEM) imaging performed.

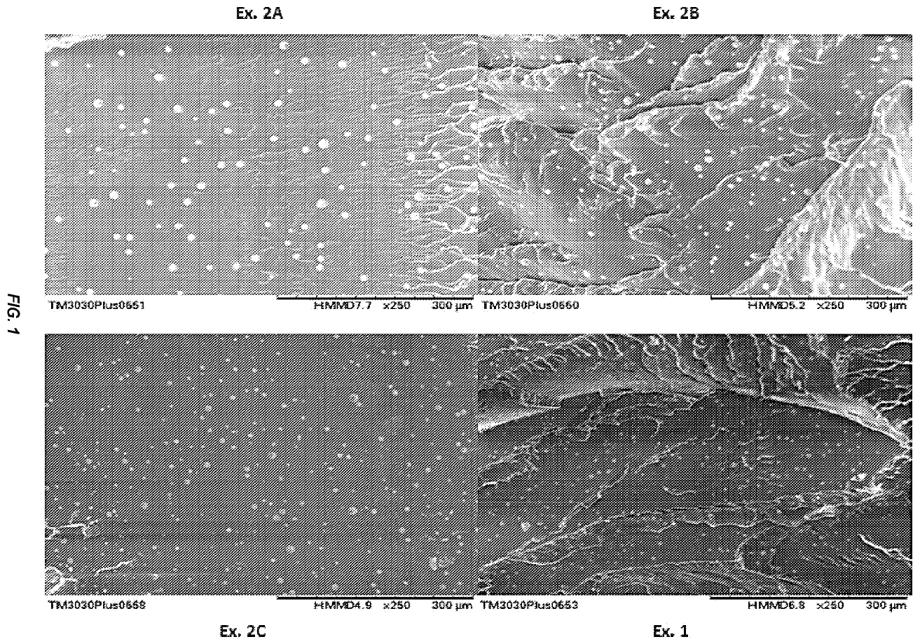

Domain sizes of the brominated copolymers were evaluated through a series of images (typically 5 images per sample) at various locations of the cross sectioned disc, representing areas at the top, middle, and bottom of the disc. FIG. 1 shows an exemplary SEM image for each of the four evaluated samples. Imaging software was used to determine the diameter of a minimum of 10 domains from each image to calculate the average domain size per sample. The results are shown in the table below. The Br-SBS copolymers of Comparative Examples 2A, 2B and 2C, which had degrees of bromination of 78% or higher (and bromine contents by weight of 61% or higher), led to higher domain sizes after dissolution in subsequently polymerized styrene monomer as compared with the Br-SBS of Example 1.

| | Percent Bromination | Bromine content | Average Domain Size |
|---|---|---|---|
| Br-SBS | of Butadiene Units | (wt %) | (μm) (SEM imaging) |
| Ex. 1 | 60% | 55% | 4.5 |
| Ex. 2A | 96% | 66% | 9.9 |
| Ex. 2B | 86% | 63% | 7.4 |
| Ex. 2C | 78% | 61% | 6.6 |

Although particular embodiments of the present invention have been illustrated and described, it will be apparent to those skilled in the art from consideration of the specification and practice of the present disclosure that various modifications and variations can be made without departing from the scope of the invention, as claimed. Thus, it is intended that the specification and examples be considered as exemplary only, with a true scope of the present invention being indicated by the following claims and their equivalents.

1. A process for producing a brominated copolymer flame retardant of at least one conjugated diene and at least one styrenic monomer, comprising reacting a copolymer of at least one conjugated diene and at least one styrenic monomer with a brominating agent in the presence of a solvent for the copolymer under conditions sufficient to brominate at least 45 percent, but no more than 70 percent, of the non-aromatic double bonds in the copolymer, wherein the copolymer prior to bromination contains from 20 to 50 percent by weight of polymerized styrenic monomer units and from 50 to 80 percent by weight of polymerized conjugated diene units, and has a weight average molecular weight of at least 1000 g/mol.

2. The process according to claim 1, wherein the copolymer of at least one conjugated diene and at least one styrenic monomer following the bromination has a bromine content by weight of from 47 to 60 percent.

3. The process according to claim 1, wherein the copolymer of at least one conjugated diene and at least one styrenic monomer is reacted with the brominating agent under conditions sufficient to brominate at least 50 percent, but no more than 68 percent, of the non-aromatic double bonds in the copolymer.

4. The process according to claim 1, wherein the copolymer of at least one conjugated diene and at least one styrenic monomer following the bromination has a bromine content by weight of from 50 to 58 percent.

5. The process according to claim 1, wherein the copolymer of at least one conjugated diene and at least one styrenic monomer prior to the bromination contains from 60 to 75 percent by weight of polymerized butadiene units and from 25 to 40 percent by weight of polymerized styrenic monomer units.

6. The process according to claim 1, wherein the weight average molecular weight of the copolymer of at least one conjugated diene and at least one styrenic monomer prior to the bromination is in a range of from 1,000 to 400,000 g/mol.

7. The process according claim 1, wherein the at least one conjugated diene is butadiene.

8. The process according to claim 1, wherein the at least one styrenic monomer is styrene.

9. The process according to claim 1, wherein the copolymer of at least one conjugated diene and at least one styrenic monomer is a block copolymer containing one or more polybutadiene blocks and one or more polymerized styrenic monomer blocks.

10. The process according to claim 9, wherein the one or more polymerized styrenic monomer blocks are one or more polystyrene blocks.

11. The process according to claim 10, wherein the copolymer is a styrene-butadiene-styrene triblock copolymer.

12. The process according to claim 1, wherein the at least one conjugated diene is butadiene and from 50 to 95 percent of the polymerized butadiene units in the copolymer prior to the bromination are 1,2-butadiene units.

13. The process according to claim 1, wherein the brominating agent comprises a tribromide chosen from pyridinium tribromide, a phenyltrialkylammonium tribromide, a benzyltrialkylammonium tribromide and a tetra-alkylammonium tribromide.

14. A brominated copolymer flame retardant of at least one conjugated diene and at least one styrenic monomer produced according to the process of claim 1, wherein at least 45 percent, but no more than 70 percent, of the non-aromatic double bonds are brominated.

15. The brominated copolymer flame retardant of claim 14, wherein average domain size after dissolution in subsequently polymerized styrenic monomer is 5 microns or less when measured using scanning electron microscopy (SEM) imaging on cross-sectioned samples.
